(19) United States
(12) Patent Application Publication
(10) Pub. No.: US 2010/0299902 A1
(43) Pub. Date: Dec. 2, 2010

(54) METHOD AND APPARATUS FOR JOINING TWO PARTS

(75) Inventors: Mikko Juhani Timperi, Raisio (FI); Tommi Antero Teuri, Teijo (FI)

Correspondence Address: Nokia, Inc., 6021 Connection Drive, MS 2-5-520, Irving, TX, 75039, US

(73) Assignee: Nokia Corporation, Espoo (FI)

(21) Appl. No.: 12/472,097

(22) Filed: May 26, 2009

(51) Int. Cl. B23P 11/00; B23P 19/00

(52) U.S. Cl. 29/428; 29/700

(57) ABSTRACT

The present application relates generally to method and apparatus for mechanically joining two parts such that the parts are movable in relation to each other.

In accordance with an example embodiment of the present invention, an apparatus comprises two parts and a join element configured to movably join the two parts—At least one of the two parts comprises an integral portion configured to hold the join element.

### TECHNICAL FIELD

The present application relates generally to method and apparatus for mechanically joining two parts such that the parts are movable in relation to each other.

### BACKGROUND

Mechanical movable joining of two body parts of an apparatus is typically used to provide a temporary compact closed position for the apparatus. Joining two body parts movably enables storing or transportation of an apparatus in a compact form. The apparatus can be in closed form, where two movable parts are close together, at least partly on top of each other. In addition to the compact temporary construction, some sensitive parts of the body can be protected in a closed position. In the closed position the inner parts are protected by a shelter or a cover formed of a body part. Further a movable joining of two body parts of an apparatus typically enables use of the device in so called open position. The open position enables blocks and/or functionalities of the apparatus to be used and sensed. Often the user is provided with the wider appearance and dimensions of the apparatus, which can enhance usability.

### SUMMARY

Various aspects of examples of the invention are set out in the claims.

According to a first aspect of the present invention, an apparatus comprises two parts and a join element configured to movably join the two parts, wherein at least one of the two parts comprises an integral portion configured to hold the join element.

According to a second aspect of the present invention, a method comprises movably joining two parts by a join element, and holding the join element to an integral portion of the at least one of the two parts.

According to a third aspect of the present invention a join arrangement, comprises a join element configured to movably join two body parts, wherein a body part comprises an integral portion, one-piece with the body part; and the integral portion configured to directly receive the join element and hold the join element, the holding enabling movable coupling of the join element and the body part.

According to a third aspect of the present invention, A body part of an apparatus, comprises an integral portion, unitary with the body part; the integral portion forming a holding part configured to directly receive a join element and hold the join element at the holding part of the body part.

### BRIEF DESCRIPTION OF THE DRAWINGS

For a more complete understanding of example embodiments of the present invention, reference is now made to the following descriptions taken in connection with the accompanying drawings in which:

FIG. 1 illustrates a top view of an example apparatus according to an embodiment of the present invention;

FIG. 2a illustrates an example of a join element coupling;

FIG. 2b illustrates a side view of an example of a join element coupling;

FIG. 3a illustrates an example apparatus according to an embodiment of the present invention;

FIG. 3b illustrates a side view of an example apparatus according to an embodiment of the present invention;

FIG. 3c illustrates a side view of an example apparatus according to another embodiment of the present invention;

FIG. 4a illustrates another example apparatus according to an embodiment of the present invention;

FIG. 4b illustrates a side view of the example apparatus of 4a according to an embodiment of the present invention; and

FIG. 5a illustrates an example apparatus according to an embodiment of the present invention.

FIG. 5b illustrates the example apparatus of 5a in a different view angle.

FIG. 6a illustrates yet another example apparatus according to an embodiment of the present invention.

FIG. 6b illustrates the example apparatus of 6a in a different view angle.

FIG. 7 illustrates an example apparatus embodying embodiment of the present invention.

FIG. 8 illustrates a flow chart according to an embodiment of the present invention.

### DETAILED DESCRIPTION OF THE DRAWINGS

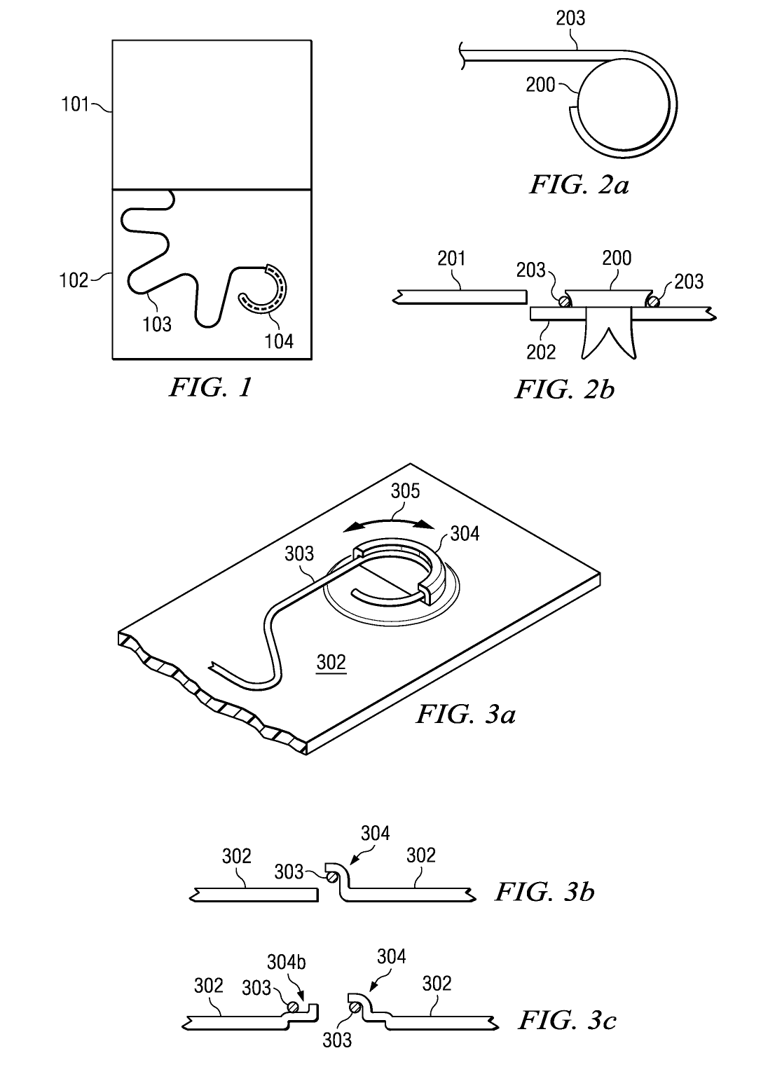

An example embodiment of the present invention and its potential advantages are understood by referring to FIGS. 1 through 8 of the drawings.

FIG. 1 illustrates a top view of an example apparatus according to an embodiment of the present invention. In the embodiment of FIG. 1 a body part 101 and a body part 102 are coupled. In this embodiment, the body parts are slidably coupled. The body parts 101, 102 may slide substantially on top of each other; or having surfaces or planes of the body parts 101, 102 against each others; or overlying in a stacked relation with respect to each others; or having surfaces or planes of the body parts 101, 102 face to face; or to so-called closed position. The body parts 101, 102 of FIG. 1 may slide substantially next to each other; or such that surfaces or planes of the body parts 101, 102 are at least partly substantially parallel; or extending away from each others; or to so-called open position. Movement of the body parts 101, 102 in relation to each other is facilitated by a join element 103. The join element 103 is configured to couple the body parts 101, 102 to each others movably. Body part 102 holds an end portion of the join element 103. Body part 102 comprises an integral portion 104 for receiving the join element 103.

According to an embodiment the integral portion 104 is provided from a body part material such that the integral portion 104 and the body part 102 form a one-piece construction. The integral portion 104 of FIG. 1 is configured to directly receive the join element 103. In an embodiment no further parts are involved in holding the join element 103. Holding is implemented solely by the body part 102, and especially the integral portion 104 of the body part 102. According to the embodiment, the integral portion 104 of a body part 102 only is needed for holding the join element 103, and for movably coupling the two body parts 101, 102. The integral portion 104 forms a holding part for the join element 103. The integral portion 104 forms at least one dimensional holding part, which is often bending outwards, or substantially perpendicular to the body part 102. The join element 103 may move in relation to the integral portion 104. The join element 103 substantially holds its place on the surface of the body part 102, but is able to slide on the surface of the body part 102, along a trail formed by the integral portion 104. For example moving the join element 103 a bit more inside the integral portion 104, or outwards from the integral portion 104, on the plane of the body part 102, is enabled.

FIG. 2a illustrates an example of a join element coupling. In FIG. 2a, an element 203 for joining two body parts together, is coupled to a body part 202 using a rivet 200. In the example of FIG. 2a join element 203 is placed around a rivet 200. The rivet 200 holds the join element 203. FIG. 2b illustrates a sectional view of an example of a join element coupling. Another body part 201 is slidably coupled to the body part 202. The join element 203 couples to the rivet 200, typically on its both ends correspondingly. One end of the join element 203 is coupled to the first body part 201 via rivet 200, and the other end of the join element 203 is coupled to the other body part 202 via another rivet fixed to the other body part. Earlier separate component/part was used as part 200. According to an embodiment of the present invention any part receiving a join element is integral and unitary with the body part.

According to an embodiment of the present invention, a body part comprises an integral portion, forming one-piece integral structure with a body part. The integral portion is configured to form a holding part, which is configured to directly receive a join element, and hold the join element at the holding part of the body part. The holding part is for example two dimensional. According to an embodiment the holding part is substantially perpendicular and substantially parallel to the body part. In the embodiment, the holding part coupling to the body part bends outwards from the substantially flat plane of the body part; and free end of the holding part, not in touch with the body part, bends substantially back to the direction of the plane surface of the body part. Any referred shape, dimension or direction must not be exactly as described, but variations are possible, as understandable. Working solution or implementation may comprise certain modifications achieving the desired result. Word substantially is used here to emphasize the non-exact meaning of words.

In one example embodiment, a substantially flat body part is stamped in order to form the integral part. A body with an integral holding part may be formed in a moulding phase, where the mould includes the shape of a holding part. The holding part of the embodiments may be formed as a trail, a groove, a slot, a track, a channel or any suitable form corresponding to the join element to be held. The holding part may be formed of one or multiple integral portions, forming appropriate form for the join element. According to the embodiments of the invention many different kind of integral portions are possible. According to an embodiment, no rivets or corresponding extra parts are used in coupling a joining element and a body part. An advantage may be that number of parts is reduced. Another possible advantage is that construction is simpler. One advantage may occur in manufacturing, when lesser parts need to be handled, positioned or included. An advantage may be that less complex structure achieved. One advantage may be use of fewer suppliers and/or parts.

A join arrangement according to an embodiment is described with the accompanying FIGS. 3a-3c. FIG. 3a illustrates an example apparatus according to an embodiment of the present invention. In the embodiment of FIG. 3a a join element 303 is configured to movably join a body part 302 to another body part. A body part 302 comprises an integral portion 304, formed from a body part material. The integral portion 304 may be formed at the same time with the body part, or after the substantially flat body part is made. The integral portion 304 is configured to directly receive the join element 303. Further the integral portion 304 is configured to hold the join element 303. According to the embodiment the holding of the join element 303 enables movable holding of the join element 303 in relation to the body part 302. Typically the join element 303 is elastic. During the movement the join element 303 is held substantially on the plane of the body part 302 by the integral portion 304. The join element 303 is sustained in the integral portion 304 during possible movement along the integral portion. The movement of the join element 303 is on the plane of the body part 302. In FIG. 3a arrow 305 shows direction of the movement of the join element 303.

FIG. 3b illustrates a side view of an example apparatus according to an embodiment of the present invention. A body part 302 comprises an integral portion 304.The join element 303 is held by the integral portion 304. The join element 303 is inserted to the integral portion 304 formed to be able to receive the join element 303. According to an embodiment the integral portion 304 is protruding outwards from the surface of the body part 302. According to another embodiment the integral portion 304 is bending inwards, forming a groove-like structure to the body part 302. The integral portion can be elongated, or made of several small portions forming an elongated groove. Shape of an integral portion may be I-, U-, J-, or L-shape, or any other one or two dimensional shape. The integral portion 304 and the join element 303 are in direct mechanical contact. The integral portion 304 is stamped, molded or otherwise formed to form a unitary part of the body part 302. The integral portion 304 may have a U-shape, an L-shape or any appropriate shape. Typically shape and dimensions of the integral portion 304 are configured to receive and movably hold the join element 303. The movable holding enables movement of the join element 303 along the integral portion 304.

FIG. 3c illustrates a side view of an example apparatus according to another embodiment of the present invention. In the embodiment of FIG. 3c a join element 303 is movably coupled to the body part 302 using integral deformed portion 304 unitary with the body part 302. Typically the join element 303 may be slided in to the trail of the integral portion 304. In the example embodiment of FIG. 3c there is provided another deformed portion. Portion 304b illustrated in FIG. 3c, is correspondingly formed integral portion as the integral portion 304 and thus forms part of the integral portion. Portion 304b is typically bent from the body part 302. The portion 304b prevents the join element 303 from displacing from its hold position in the integral portion 304. Usually the portion 304b does not touch the join element 303. Mostly the portion 304b ensures that the join element 303 holds in place in the sliding hold coupling formed with the integral portion 304.

An advantage of the embodiments shown with FIGS. 3a-3c may be less complex structure achieved. One advantage may be reliability of the arrangement.

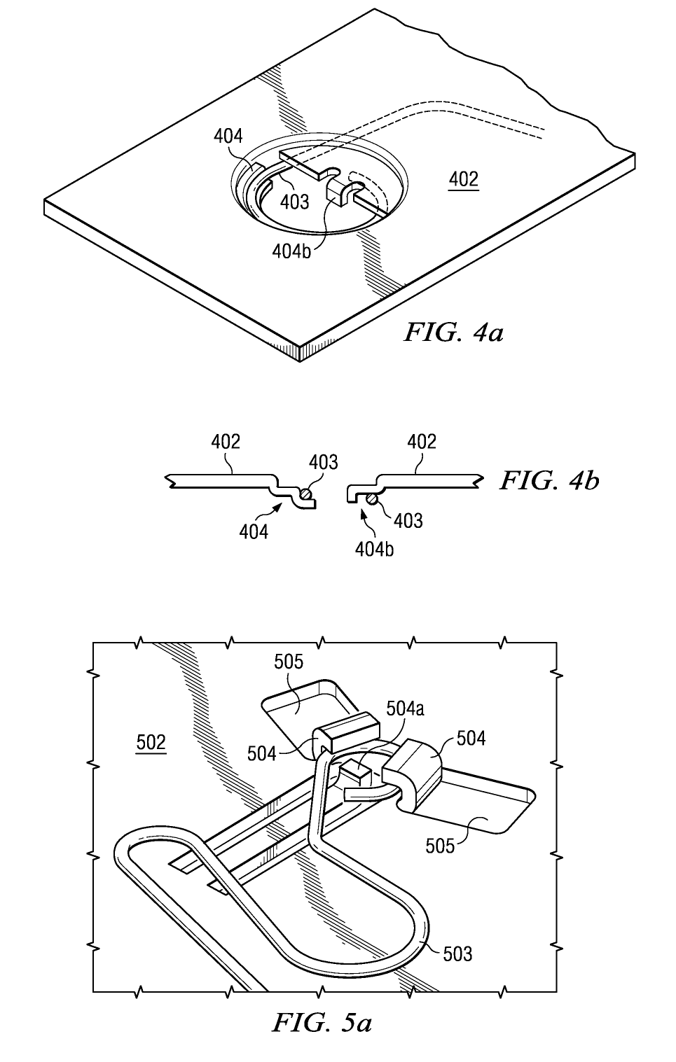

FIG. 4a illustrates another example apparatus according to an embodiment of the present invention. FIG. 4a illustrates a body part of a housing, e.g. to be coupled to the body part 302. In this example the integral portion 404 is forming one-piece, unitary structure with the body part 402, being bent downwards from the plane of the body part 402. The integral portion 404 comprises two dimensions. The dimensions of the integral portion 404 are parallel and perpendicular to the plane of the body part 402. The join element 403 is placed in the trail formed by the dimensions and shape of the deformed integral portion 404 of the body part 402. The other unitary integral portion 404b is configured to fix the coupling. In other words the other bend integral portion 404b is for holding the join element 403 at the right place, preventing it from escaping from the holding integral portion 404.

FIG. 4b illustrates a side view of the example apparatus of 4a according to an embodiment of the present invention. The body part 402 has at least two deformed portions 404, 404b. The join element 403 is held by one deformed portion 404. The deformed portion 404b is for ensuring the holding of the deformed portion 404. The deformed portion 404b generally prevents unintentional detachment of the join element 403 and the integral portion 404.

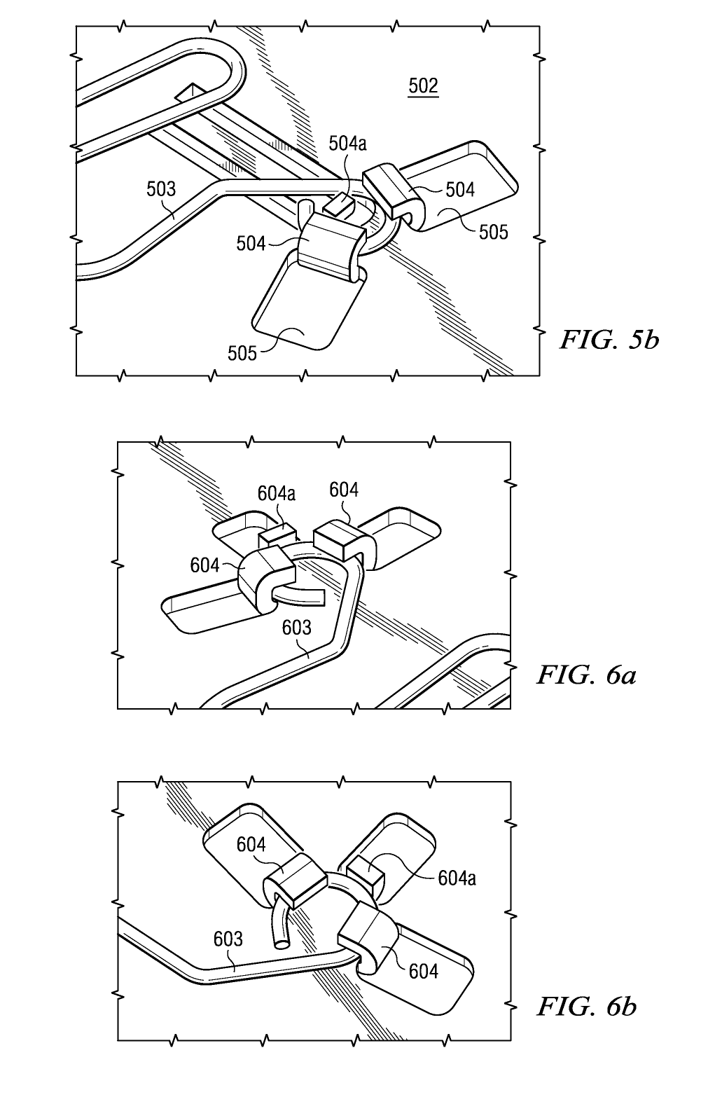

FIG. 5a illustrates yet another example apparatus according to an embodiment of the present invention, and FIG. 5b illustrates the example apparatus of 5a in a different view angle. The embodiment is implemented on a housing body part 502, which may be a metal housing. A body part 502 of the example embodiment comprises unitary integral portion 504 at least partly corresponding to the dimensions of the join element 503. The integral portion 504 holdably and movably holds the join element 503 to the body part 502. In an example embodiment a body part 502 comprises unitary integral portions 504 to hold the join element 503 to the unitary integral portions 504. The holding is movable such that the join element is able to move along the unitary integral portions, on the surface of the body part. The holding is permanent such that the place of the join element in relation to the body surface is fixed by the holding parts of the integral portion.

The integral portions 504a may be used to ensure the holding. The integral portion 504a is flexible. Flexibility is implemented in the example of FIGS. 5a-b by elongated integral leg. The structure for ensuring the placement of the join element 503 is implemented by bending the free end of the leg upward towards the body 502 plane surface. According to an embodiment the bent ensuring structure is small compared to whole/rest of the integral portion. Flexibility of the part 504a ensuring the hold of the join element may be implemented in many different ways, e.g. using flexible material, depending on the other structure, design or freedoms/limitations available to a skilled person. In the embodiments illustrated in FIGS. 5ab the integral portion 504, 504a comprises more than one part. The integral portion 504 may comprise separate parts deformed from the body part 502. Typically parts of the integral portion 504 together correspond to the shape of the join element 503. Parts of the integral portion 504 together correspond to the dimensions of the join element 503.The integral portion 504 is configured to receive and movably hold the join element 503. According to an embodiment a unitary integral portion at least partly corresponds to the dimensions of the join element. The unitary integral portion having two or more holding parts is configured to hold the join element.

According to an embodiment a body part comprises deformed integral portion. The portion may be for example worked, stamped, embossed or molded from the original substantially flat housing. Generally the integral portion may be made of the body part by any convenient manner, like electromagnetic forming, hydraulic forming, hydro forming, pressing, hydraulic press, punching, shearing, hot-/cold rolling, and/or with aid of a suitable die. In the example embodiment of FIGS. 5ab, the integral portion 504 (504a) is e.g. pressed with an embossed pattern. According to one embodiment the integral portion is stamped from a substantially flat housing, and the stamped portion bent. In the FIGS. 5ab a sheet 505 of a body part is deformed to form the integral portion 504 (504a). Accordingly, there is a corresponding hole 505 left in the original body part. When alternative means, e.g. moulding, is used for forming the integral portions, there may be e.g. no holes, or smaller holes, not necessarily corresponding to the shape or size of the integral portion 504. Many different implementations are possible within the scope and embodiments of the present invention. The integral portion is such that a used join element fits in. I.e. dimensions of a join element determine the shape and/or the dimensions of the integral portion. According to one example embodiment the unitary integral portion comprises a holding part having dimensions bending substantially away and back towards to the substantially flat body part. The integral portion may still have many different implementations involving one to multiple parts. The trail formed using the deformated portions corresponds to the insertable join element. According to one example, the integral portion has U-shape corresponding to the shape and dimensions of the join element. In another example unitary integral portion formed of at least two integral parts deformed from the body part corresponds at least partly to the dimensions of the join element. The integral portion is configured to hold the join element, while allowing movement of the join element along the integral portion. In one embodiment unitary integral portions are configured to permanently couple the join element to the unitary integral portions. Further the unitary integral portions may be configured to fix the coupling

FIG. 6a illustrates yet another example apparatus according to an embodiment of the present invention. Here the join element 603 is held by the integral portions 604. The integral portions are formed from the material of the body part such that a unitary body part including integral portions is formed. In this example, the fixing part ensuring the holding is formed using a third integral portion 604a. Here the two integral portions 604 comprising a bent structure are used to hold the join element 603 in two dimensions. The third integral portion 604a is used for holding the join element in one dimension. One dimension is typically the surface of the body part, being parallel to the plane. The other dimension being substantially perpendicular to the plane or surface of the body part. FIG. 6b illustrates the example apparatus of 6a in a different view angle.

An apparatus according to an embodiment of the present invention comprises two parts. At least one of the two parts may be a metal housing. A join element is movably joining the two parts. At least one of the two parts comprise an integral portion configured to couple the at least one of the two parts and the join element. The integral portion according to embodiment of the invention is deformed from a body part of the at least one of the two parts. According to an embodiment the integral portion and the join element are in direct mechanical contact. The join element is correspondingly coupled to the both body parts to be movably coupled.

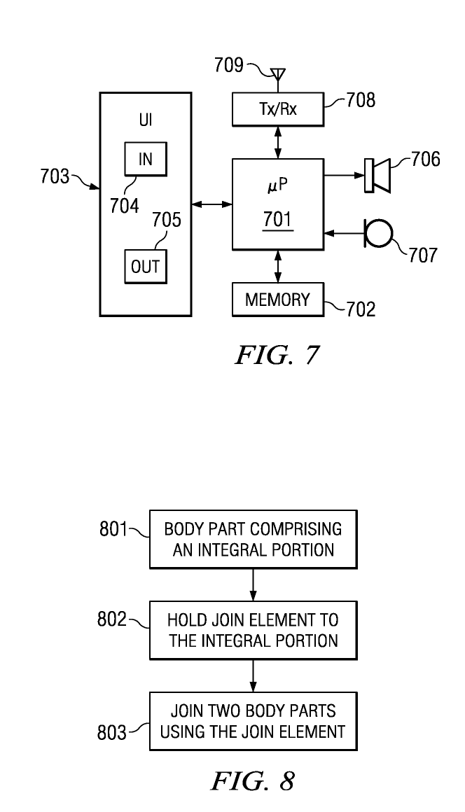

FIG. 7 illustrates an example apparatus embodying embodiment of the present invention. The apparatus comprises a processor 701 configured to process and/or execute digital data, e.g. instructions or program code. The processor 701 may transmit any processed or raw data, or receive data to be processed to/from a memory 702. The memory may comprise any suitable structure or combination of memory types, like read-, write-, volatile-, or non-volatile memory. The memory 702 may comprise one memory block, shared memory blocks, or multiple different or similar kinds of memory blocks. The apparatus comprises user interface 703 configured to enable user interaction. Typically user interface 703 comprises input block 704, which may be at least one of a key, a keyboard, a touch input, a mouse, a stylus or any other input mean. Typically user interface 703 comprises output block 705, which may be for example a display, or any other mean or combination of means enabling presentation of information comprising e.g. visual-, audio-, or multimedia data. Further the example apparatus of FIG. 7 comprises speaker 706 for outputting audio data of any type and microphone 707 for inputting audio data of any type. The example apparatus further comprises transmission branch 708 configured to enable communication via network. The transmission branch 708 enables transmitting and receiving of data via antenna 709 to/from the network. The apparatus may additionally or alternatively comprise cable connector for enabling connecting to the network. FIG. 7 illustrates one typical example only and it is clear that embodiments of the present invention may be implemented in different kind apparatuses embodying only part of the presented apparatus blocks, and/or other known apparatus blocks.

Embodiments of the present invention may be implemented in an apparatus comprising at least two movably joined parts. The apparatus may be for example a laptop, a computer, a mobile phone, a mobile computer, a personal digital assistant, an intelligent digital device, a game device, or any other apparatus comprising at least two body parts, which are movable in relation to each other. Besides a shell structure, where two parts are substantially equal in size, the movable part may include e.g. an extra display, which is movable in view of one part of the apparatus; or a camera module, movable in view of a body part of the apparatus. Movement of the parts in relation to each others may be, but is not limited to, sliding type of movement, and rotational movement.

Mechanical movable joining may enable size of an apparatus to be temporary compact. Joining two body parts movably typically enables storing or transportation in a compact form. An apparatus may be in a closed position, where two movable parts are close together, e.g. at least partly on top of each other. Often an apparatus comprises some sensitive part, like visual output or input block, e.g. a display, a touch input area, a keyboard, different kind of buttons, input areas, and so on. Sensitive parts of the apparatus may be protected in the closed position. Sensitive parts may be protected against any external factor, like mechanical touch, dust, dirt, and so on. The so called closed position typically protects sensitive parts by forming a shelter or a cover temporary with aid of one body part of the apparatus.

A movable joining of two body parts of an apparatus typically enables use of the apparatus in its so called open position. The open position typically widens up the user interface. In the open position blocks or functionalities of the device are enabled. Typically functions of the apparatus are made available to be used and/or sensed. Often the user is provided with the wider appearance and dimensions of the apparatus. Open position may enhance usability of the apparatus.

An example join element has elastic properties. The join element structure may be deflected, bended, coil or helical. According to one example, the join element is a spring. In one embodiment the join element is an actuator. The join element may have a bended structure, enabling movement based on its elasticity. A join element may have a structure enabling rotating movement, e.g. a coil-like structure. A join element may be a helical spring having axes and/or form a (clothes-) peg type of structure. The axes of a join element may receive a body part according to an embodiment of the invention. FIG. 8 illustrates a flow chart according to an embodiment of the present invention. The flow chart illustrates movably joining two parts by a join element; and holding the join element to an integral portion of the at least one of the two parts. The part, typically called as a body part, comprises an integral portion 801. The integral portion may comprise two dimensions. The unitary integral portion comprises a holding part having dimensions substantially parallel and substantially perpendicular to the surface of the part. The integral portion may be deformed from a body part, or molded in a same mould with a body part of the at least one of the two parts. The integral portion holds a join element 802. Typically the integral portion and the join element are in direct mechanical contact. According to an embodiment the integral portion comprises unitary integral portion at least partly corresponding to dimensions or shape of the join element. In one embodiment one or both of two parts comprise unitary integral portions configured to permanently hold the join element in one dimension. The two parts held by at least in one of rotatable and slidably manner. The two body parts of an apparatus are connected using the join element 803. The body parts are connected movably to each other so that they are able to move in relation to each other, as allowed by the connection.

Without in any way limiting the scope, interpretation, or application of the claims appearing below, a technical effect of one or more of the example embodiments disclosed herein is reduced number of parts of the construction or apparatus. Another technical effect of one or more of the example embodiments disclosed herein is a simple construction. Another technical effect of one or more of the example embodiments disclosed herein is easier assembly. Another technical effect of one or more of the example embodiments disclosed herein is providing reliable join arrangement.

If desired, the different parts discussed herein may be arranged in a different order. Furthermore, if desired, one or more of the above-described parts and their functions may be optional or may be combined.

Although various aspects of the invention are set out in the independent claims, other aspects of the invention comprise other combinations of features from the described embodiments and/or the dependent claims with the features of the independent claims, and not solely the combinations explicitly set out in the claims.

It is also noted herein that while the above describes example embodiments of the invention, these descriptions should not be viewed in a limiting sense. Rather, there are several variations and modifications which may be made without departing from the scope of the present invention as defined in the appended claims.

1. An apparatus, comprising:
two parts; and
a join element configured to movably join the two parts;
wherein at least one of the two parts comprises an integral portion configured to hold the join element.

2. An apparatus according to claim 1, wherein the integral portion comprises two dimensions.

3. An apparatus according to claims 1, wherein the integral portion comprises a holding part having dimensions substantially parallel and substantially perpendicular to the surface of the part.

4. An apparatus according to claim 1, wherein one end part of the integral portion, configured to be connected to a body part of one of the two parts, and to be bent outwards from the substantially plane of the body part; and the other, free end of the integral portion, configured to be bent substantially towards the direction of the plane surface of the body part.

5. An apparatus according to claim 1, wherein the integral portion is unitary with a body part of one of the two parts.

6. An apparatus according to claim 1, wherein the integral portion is one of: deformed from a body part of the at least one of the two parts; and molded in a same mould with a body part of the at least one of the two parts.

7. (canceled)

8. An apparatus according to claim 1, wherein the integral portion and the join element are in direct mechanical contact.

9. An apparatus according to claim 1, wherein the at least one of the two parts comprises unitary integral portion at least partly corresponding to the dimensions of the join element.

10. (canceled)

11. An apparatus according to claim 1, wherein the at least one of the two parts comprises unitary integral portion configured to movably hold the join element at least in one dimension.

12-14. (canceled)

15. A method, comprising:
movably joining two parts by a join element; and
holding the join element to an integral portion of the at least one of the two parts.

16. A method according to claim 15, wherein the integral portion comprises two dimensions.

17. A method according to claim 15, wherein the integral portion comprises a holding part having dimensions substantially parallel and substantially perpendicular to the surface of the part.

18. A method according to claim 15, wherein one end part of the integral portion, connecting it to a body part of one of the two parts, bending outwards from the substantially plane body part; and the other, free end of the holding part, bending substantially towards the direction of the plane surface of the body part.

19. A method according to claim 15, wherein the integral portion is unitary with a body part of one of the two parts.

20. A method according to claim 15, wherein the integral portion is one of: deformed from a body part of the at least one of the two parts; and molded in a same mould with a body part of the at least one of the two parts.

21-22. (canceled)

23. A method according to claim 15, wherein the integral portion comprises unitary integral portion at least partly corresponding to dimensions of the join element.

24. A method according to claim 15, wherein the integral portion comprises unitary integral portion at least partly corresponding to the shape of the join element.

25-27. (canceled)

28. A body part of an apparatus, comprising:
an integral portion, unitary with the body part; the integral portion forming a holding part configured to directly receive a join element and hold the join element at the holding part of the body part.

29. A body part according to claim 28, wherein the integral portion comprises a two dimensional holding part.

30. A body part according to claim 28, wherein the unitary integral portion comprises a holding part having dimensions bending substantially away and back towards to the substantially flat body part.
